(19) United States
(12) Patent Application Publication
(10) Pub. No.: US 2016/0229073 A1
(43) Pub. Date: Aug. 11, 2016

(54) ROW RAZOR

(71) Applicant: KEISE LTD., Tochigi (JP)

(72) Inventor: Yoshio YABE, Utunomiya-Shi, Tochigi (JP)

(73) Assignee: Keise Ltd., Utunomiya-Shi, Tochigi (JP)

(21) Appl. No.: 15/022,997

(22) PCT Filed: Feb. 24, 2014
(86) PCT No.: PCT/JP2014/054395

§ 371 Date: Mar. 18, 2016

(51) Int. Cl. B26B 21/24; B26B 21/40

(52) U.S. Cl. CPC B26B 21/24; B26B 21/4012

(57) ABSTRACT

The present invention provides a row razor where a plurality of razor blades is sequentially arranged at a flat band body and allows selectively using any given razor blade. A basic constitution of the row razor is as follows. The row razor has a plurality of razor blades arranged in a row at a flat band body. These razor blades are sequentially arranged at the flat band body so as to provide predetermined intervals and have a predetermined inclined angle. This flat band body is one piece flat belt or flat endless belt using a material of flexible resin or rubber. Cut portions, which are perforations, are formed providing a predetermined interval. Engaged portions for feed mechanism are sequentially formed at an approximately edge portion on one side or both sides of this flat band body. The engaged portions for feed mechanism are capable of feeding this flat band body.

### TECHNICAL FIELD

The present invention relates to a razor blade, more specifically, relates to a row razor that includes a plurality of continuous razor blades on a belt-shaped body.

### BACKGROUND ART

As a knife for removing mustaches, hair, or a body hair at a surface of a skin, there is provided a razor. The razor is widely and generally used irrespective of age and sex to fix his/her personal appearance. Nowadays, products that have a plurality of extremely thin steel blades aiming to improve sharpness, such as three blades or four blades, enter the mainstream. Roughly dividing the products, there is provided a disposable type of simple structure with integrated these plurality of blades and a handle and a cartridge exchanging type with a plurality of blades secured with plastic. In particular, in terms of a cost or a similar problem, a razor for shaving provided at a business trip destination, a hotel at a travel destination, or a similar place is often a disposable type with integrated blades and the handle. This razor has simplified overall design and function. In contrast to this, the cartridge exchanging type often includes a bobble head mechanism.

Typically, a highly functional razor is used at home while the simplified razor is used for travelling or a similar purpose. However, the use of the highly functional razor for travelling or a similar purpose has been often requested. Actually, some people bring the razor used at home to the travel destination. In this case, if not bringing the cartridge of a razor head, a worn razor blade cannot be exchanged at the travel destination, failing to achieve the original purpose. The cartridge is possibly purchased at the travel destination. However, the shape of the cartridge does not meet a public standard such as the JIS standard or a similar standard nor meet a so-called industry standard (de fact standard) as a practical standard. Furthermore, even the same manufacturer, a configuration often differs defending on a model. To solve these disadvantages, a razor that can employ a plurality of highly functional razor heads alone without additional other goods has been requested. Additionally, as another form of use, when changing a razor put at a guest room of a hotel from the simplified type to the highly functional type to improve service in the hotel, placing one handle and the cartridges by the number of persons is more economical than placing the razors by the number of persons. However, if not accustomed, exchanging the cartridge is troublesome work. Furthermore, exchanging the cartridge several times in a short time is complicated. Accordingly, this sometimes ends up causing the user to feel an inconvenience.

To solve such inconveniences, a razor whose highly functional razor head alone can be quickly changed easily has been desired. Regarding the cost, one new replacement blade for a twin blade razor is about 40 to 50 yen. In contrast to this, one new replacement blade for the cartridge type razor is about 250 to 300 yen, which is almost six times as expensive as the new replacement blade for the twin blade razor. This is due to the structural problem and material. This is also a harmful influence caused by enhancing goodness of sharpness by the use of an expensive material such as carbon or titanium. Even the razor blade featuring good sharpness and made of an expensive material, if the sharpness is degraded, the razor blade needs to be exchanged. If hesitating the exchange and lengthening the cycle of the exchange, the sharpness is degraded, negatively affecting skin. An ordinary razor blade made of stainless steel can cut well if the ordinary razor blade is new.

In the technical field of such razor, for example, the “safety razor” (see Patent Literature 1) has been proposed, and this has been a publicly-known technique. The safety razor has an inner blade and a cylindrical outer blade. The inner blade is horizontally supported to a holder portion. The outer blade rotatably coats the inner blade and has countless insertion holes for mustaches. Additionally, a “long-handle blade” (see Patent Literature 2) has been proposed, and this has been a publicly-known technique. The shaving blade of the long-handle blade is fixedly secured to a blade base, thus the new replacement blade is formed. On the other hand, a pair of supporting members, which supports and secures the new replacement blade so as to be exchangeable, is disposed in a longitudinal direction of the holder providing a constant interval. Furthermore, a biasing member, which biases at least one of both supporting members to a direction of supporting the new replacement blade, is disposed. A “bidirectional shaving implement” (see Patent Literature 3) that allows reverse shaving in shaving in any direction by attaching two razor blades to one handle such that the two razor blades are opposed to one another has been proposed, and this has been a publicly-known technique.

With these safety razors, the razor head can be easily exchanged according to wear of the razor blade, thus the worn razor blade can be changed to a new razor blade. However, during the change, the cartridge or a new razor blade needs to be prepared. In view of this, the above-described problem has not been solved. To solve the problems, the inventor have focused on arranging the plurality of razor blades on one flat band body, selecting any given blade, and easily using the razor. Thus, the inventor has proposed the “row razor.”

### CITATION LIST

### Patent Literatures

Patent Document 1: Japanese Unexamined Utility Model Application Publication No. 2-134976

Patent Document 2: Japanese Unexamined Utility Model Application Publication No. 61-164668

Patent Document 3: Japanese Unexamined Patent Application Publication No. 2007-519500

### SUMMARY OF INVENTION

### Problems to be Solved by the Invention

To solve the problems, the present invention ensures providing a row of razor blades that include a plurality of razor blades sequentially at a belt-shaped body to allow using the razor blades for different purposes according to an individual difference of a user and a situation of use.

### Solutions to the Problems

A row razor according to the present invention includes a plurality of razor blades arranged in a row at a flat band body. The row razor employs the following structural means. The row razor includes the razor blades, the flat band body, cut portions, and engaged portions for feed mechanism. These razor blades are sequentially arranged at the flat band body providing a predetermined interval. This flat band body has one or more of a flat belt shape or a flat endless belt shape using a material any one of or a combination of flexible resin, rubber, and metal. The cut portions are formed providing a predetermined interval. The cut portions are weakened to facilitate cutting. The cut portions are formed of grooves for cutting or perforations. The cut portions are formed at an approximately edge portion on one side or both sides of this flat band body providing a predetermined interval. The cut portion is one piece flat belt or a flat endless belt. The engaged portions for feed mechanism are sequentially formed at an approximately edge portion on one side or both sides of this flat band body. The engaged portions for feed mechanism are capable of feeding this flat band body.

The row razor according to the present invention may also employ the following structural means. The flat band body is integrally formed with razor holding blocks that have a continuous shape. The razor blade holding blocks hold a group of at least two or more of razor blades. The cutting portion is disposed between these razor blade holding blocks.

The row razor according to the present invention may also employ the following structural means. The row razor is formed with a shaver case. The shaver case incorporates the row razor. This shaver case covers the entire row razor blades. The shaver case has an opening. The opening exposes a part of a razor blade to be used such that the razor blade is brought into contact with skin. The shaver case is provided with a feed mechanism. The feed mechanism allows selecting a razor blade at any given position among the razor blades arranged at the flat band body.

The row razor according to the present invention may also employ the following structural means. The opening is provided with an opening area variable mechanism.

### Effects of the Invention

With the row razor according to the present invention, a plurality of razor blades is sequentially arranged in a row. This allows selection according to the number of blades and wear of the blades corresponding to hair quality at a site to be shaved or a similar condition. This eliminates the need for looking for a cartridge or a similar part, allowing facilitating a change to a new razor blade. Accordingly, the user's convenience is improved.

The row razor according to the present invention provides the following excellent effects. That is, since only a part of used razor blade can be cut at the cut portion, the row razor is hygienic. Meanwhile, even if an effective cycle of the razor blade is short like the case where the person frequently uses the razor, the person has thick mustache, or a similar situation, the row razor allows reducing a burden of the complicated exchanging work.

With the row razor according to the present invention, the razor blades are arranged at one piece flat belt or flat endless belt. This eliminates the need for an individual head member unlike to the cartridge type. This provides excellent effect of low cost.

### BRIEF DESCRIPTION OF THE DRAWINGS

FIGS. 1(a) and 1(b) are explanatory views illustrating an arrangement of razor blades at a flat band body (one sheet-shaped) according to the present invention.

FIGS. 2(a) and 2(b) are explanatory views illustrating an arrangement of the razor blades at the flat band bodies (multiple band-shaped) according to the present invention.

FIGS. 3(a) and 3(b) are explanatory views illustrating an arrangement of the razor blades at the flat band body (block-shaped) according to the present invention.

FIGS. 4(a) and 4(b) are explanatory views illustrating similar patterns of the flat band body (one piece type and endless type) according to the present invention.

FIGS. 5(a) and 5(b) are explanatory views illustrating a mounting state to a shaving case in an endless belt specification.

FIGS. 6(a) and 6(b) are explanatory views illustrating a mounting state to the shaving case in a one piece flat belt specification.

FIGS. 7(a) to 7(c) are explanatory views illustrating a mounting state to the shaving case in a specification of a row of razor with frame body.

FIG. 8 is an explanatory view illustrating an opening area variable mechanism according to the present invention.

FIG. 9 is an explanatory view illustrating the flat band body according to the present invention that has both a block shape and an endless type.

FIGS. 10(a) and 10(b) are explanatory views illustrating a mounting state to a simplified case in the one piece flat belt specification.

### DESCRIPTION OF EMBODIMENTS

The greatest feature of a row razor 1 of the present invention is as follows. A plurality razor blades 5 are sequentially arranged at a flat band body 8, and any given razor blade 5 can be easily selected. Accordingly, an inconvenience due to wear of these razor blades 5 can be solved without using another member. Embodiments will be described hereinafter with reference to the attached drawings.

An overall shape and shapes of respective portions of the row razor 1 described in the embodiments are not limited to the embodiments disclosed later. The overall shape and the shapes of respective portions can be modified within the scope of the technical idea of the present invention, that is, within the scope of the shape and dimensions where the same actions and effects can be achieved.

### First Embodiment

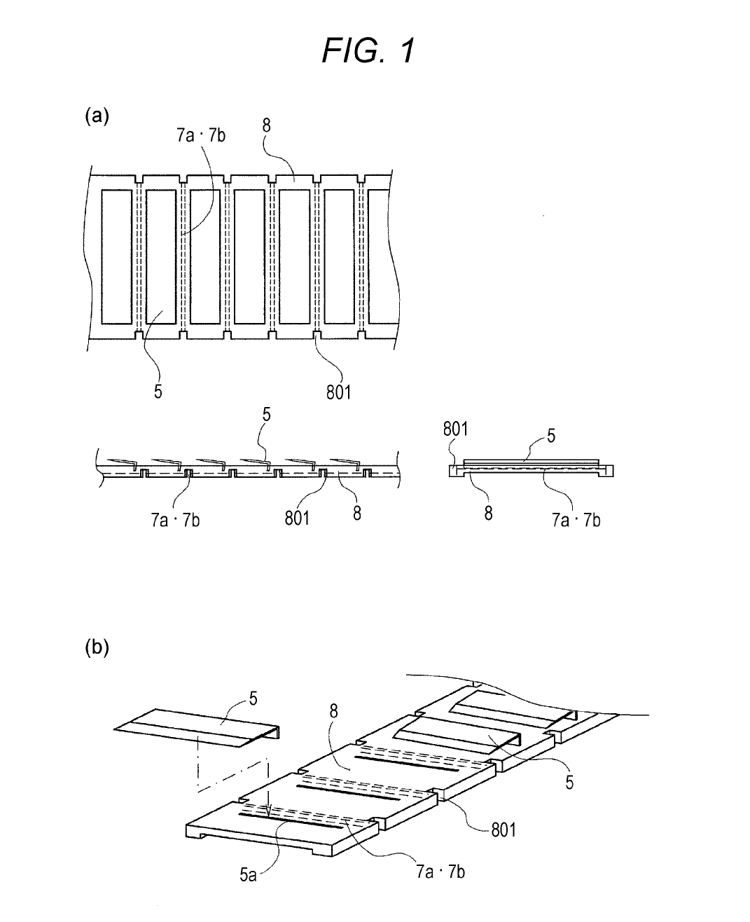

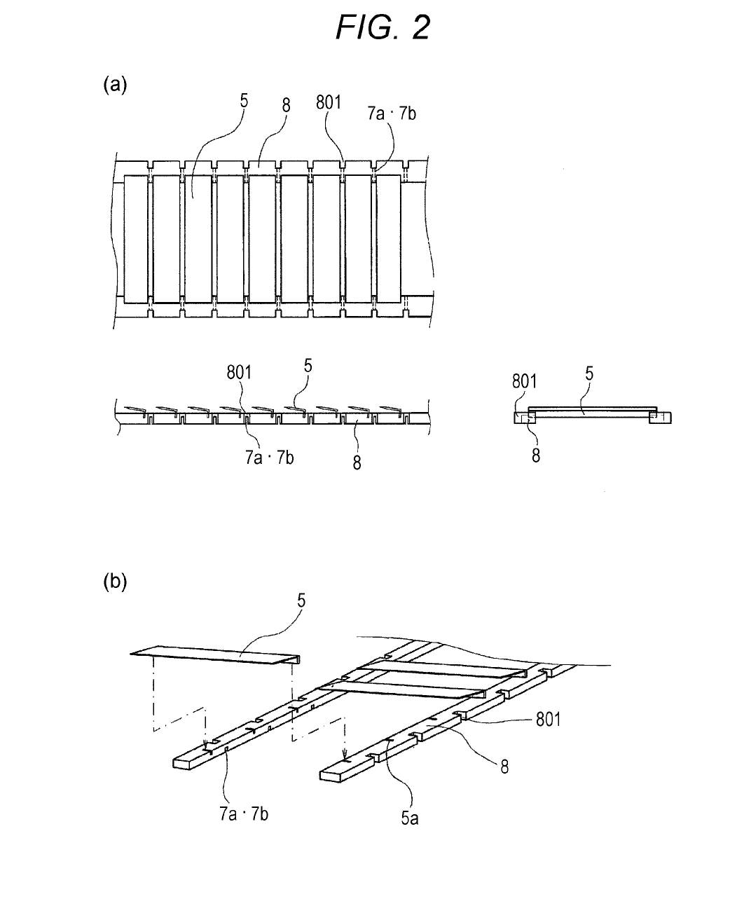

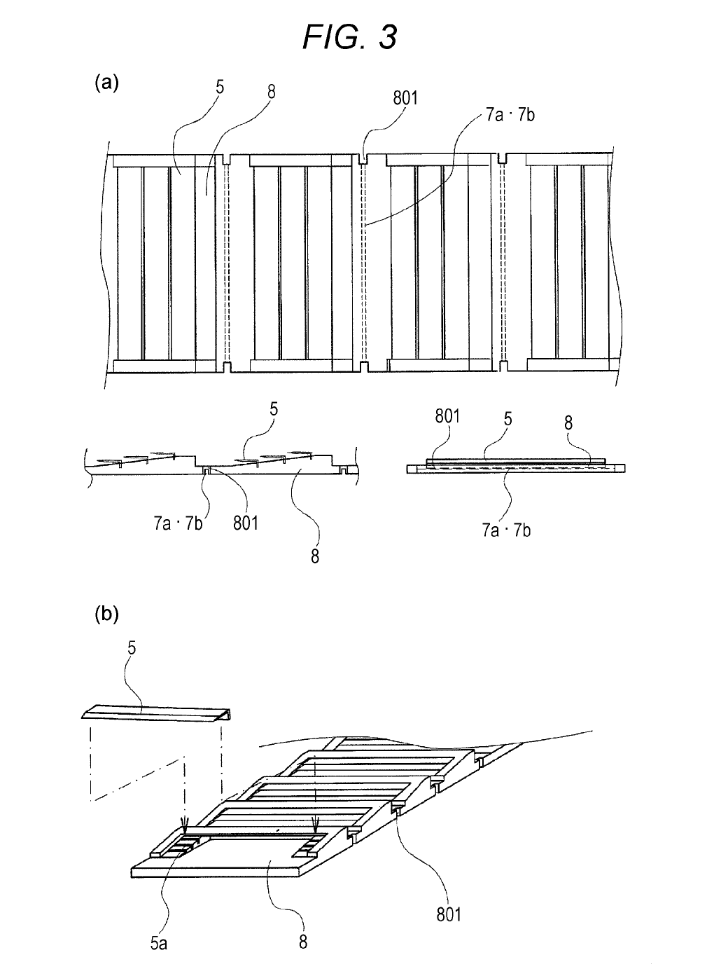

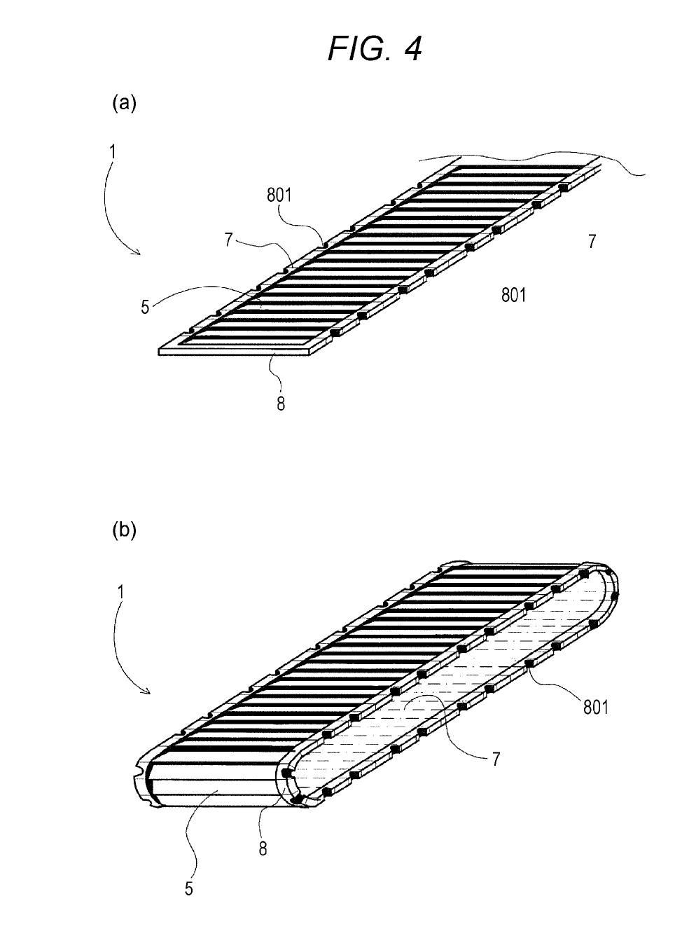

The following describes the present invention based on FIGS. 1(a) to 9. FIGS. 1(a) and 1(b) are explanatory views illustrating an arrangement of razor blades in the case where a flat band body according to the present invention has a one sheet shape. FIG. 1(a) are views of three surfaces, and FIG. 1(b) is a perspective view. FIGS. 2(a) and 2(b) are explanatory views illustrating an arrangement of the razor blades in the case where flat band bodies 8 according to the present invention are plurality of bands. FIG. 2(a) are views of three surfaces, and FIG. 2(b) is a perspective view. FIGS. 3(a) and 3(b) are explanatory views illustrating an arrangement of the razor blades in the case where at least two or more of the flat band bodies 8 according to the present invention are included in block-shaped frame bodies. FIG. 3(a) are views of three surfaces, and FIG. 3(b) is a perspective view. FIGS. 4(a) and 4(b) are perspective views illustrating the entire flat band body 8 according to the present invention. FIG. 4(a) illustrates an embodiment of one piece flat belt 8b, and FIG. 4(b) illustrates an embodiment of a flat endless belt 8a.

The flat band body 8 is the one piece flat belt 8b or the flat endless belt 8a. The one piece flat belt 8b employs a material of flexible resin or rubber. The razor blades 5 are sequentially arranged at the flat band body 8 so as to provide predetermined intervals and have a predetermined inclined angle. Fragile cut portions 7 are formed providing predetermined intervals so as to facilitate cutting. This cut portion 7 is possibly a groove for cutting or a perforation. The cut portion 7 is not limited to these. For example, the cut portion 7 may become fragile compared with other parts by bonding the predetermined number of razor blades 5 in a soft state in every one block with adhesive or elastomer-based adhesive.

Engaged portions for feed mechanism 801 are sequentially formed at an approximately edge portion on one side or both sides of this flat band body 8. The engaged portions for feed mechanism 801 are capable of feeding this flat band body 8. The engaged portions for feed mechanism 801 illustrated in FIGS. 1(a) to 4(b) are examples of when a drive roller includes a convex portion. A dial 13 is in contact with a handle side roller 10. Rotation of the dial 13 is transmitted to the handle side roller 10 without sliding. A coupling surface between the dial 13 and the handle side roller 10 may be coupled simply by friction or may be coupled using fine convexo-concave shapes.

The material is not especially limited. It is only necessary that the material have required elasticity and strength. For example, synthetic rubber such as nitrile rubber and silicon rubber is preferable. Furthermore, when made of rubber with low heat resistance and cold resistance, since this material is likely to cause a degradation phenomenon such as hardening and weakening, this material should be avoided. If using resin, fluororesin or a similar material is preferable due to the bending property or a similar property. However, when using a reinforced fiber such as a glass fiber or aramid cloth, cutting by the cut portion 7 at the perforation becomes difficult. Accordingly, a resin material that is easily bent and is easily cut is employed.

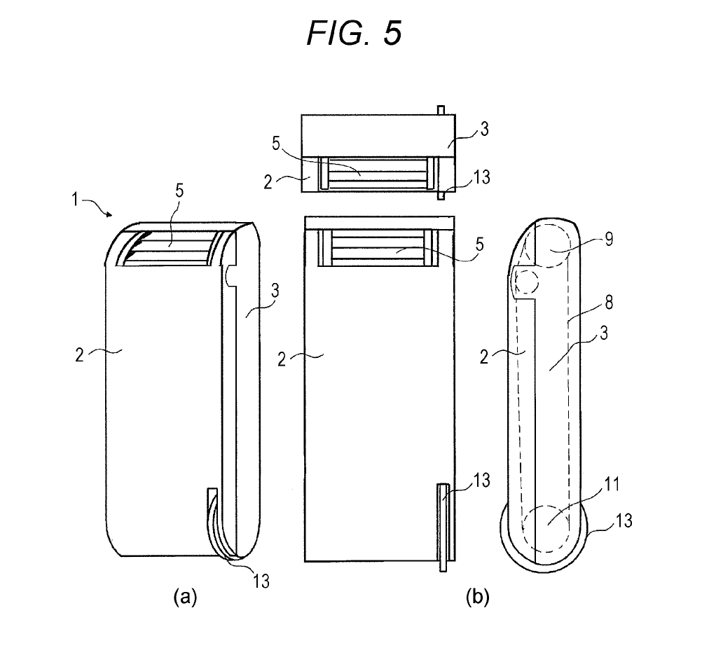

FIGS. 5(a) and 5(b) are explanatory views illustrating a mounting state to a shaving case 2 in the case where the flat endless belt 8a is used as the flat band body 8. FIG. 5(a) is a perspective view, and FIG. 5(b) are views of three surfaces. The endless belt 8a is secured by an opening side roller 9 and the handle side roller 10. The dial 13 is in contact with the handle side roller 10. Rotation of the dial 13 is transmitted to the handle side roller 10 without sliding. A coupling surface between the dial 13 and the handle side roller 10 may be coupled simply by friction or may be coupled using fine convexo-concave shapes.

### Second Embodiment

The row razor 1 according to claim 3 and claim 4 has the following constitution. The row razor 1 is covered with a front side shaver case 2a and a back side shaver case 2b as illustrated in FIGS. 5(a) to 7(c). The razor blades 5 are exposed from an opening 30. The dial 13 at the lower portion is rotatable with a finger, or a similar tool. The razor blades 5 are secured to the endless belt 8a. The movement of the endless belt 8a causes the razor blades 5 to come from and go to the inside of the shaver case 2. The shaver case 2 is constituted of the front side shaver case 2a and the back side shaver case 2b. The shaver case 2 has a width in which the razor blades 5 can be housed. The vertical length of the shaver case 2 is similar to a vertical length of a shaver case of an ordinary razor. This length may be slightly longer according to the number of razors 5 housed in the flat band body 8 to be housed. The material is possibly general synthetic resin or a similar material. For example, the material is ABS resin, acrylic resin, or similar resin.

Both the front side shaver case 2a and the back side shaver case 2b have a top portion inclined to a surface direction. Opening side roller securing portions 11 and handle side roller securing portions 12 are disposed at an inner side surface of the back side shaver case 2b. The opening side roller securing portions 11 and the handle side roller securing portions 12 secure the opening side roller 9, an opening side inclined roller 9a, and the handle side roller 10. The opening side roller securing portions 11 are arranged at both inner surfaces at the upper portions of the back side shaver case 2b. The opening side roller securing portions 11 have a function that secure the opening side roller 30 from both sides and promote smooth rotation. The handle side roller securing portions 12 are arranged at both inner bottom surfaces of the back side shaver case 2b. The handle side roller securing portions 12 have a function that secures the handle side roller 10 and the dial 13 from both sides.

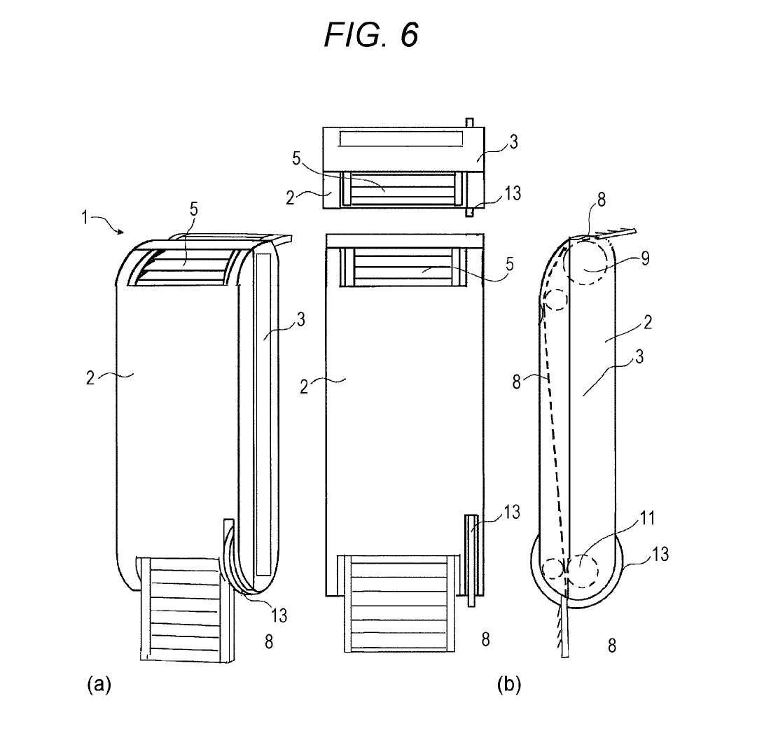

A surface of the opening 30 is inclined frontward. For comfortable shaving, the razor blades 5 or razor razor blade holding blocks 4 may be obliquely arranged with respect to a handle part. The row razor 1 has the handle part at a part slightly lower with respect to the case center. In view of this, the opening 30 is preferable to be used at the part obliquely arranged with respect to the case. Therefore, the opening 30 has a shape obliquely cut with respect to the front side shaver case 2a. When using the continuous razor blade holding blocks 4 as well, the position of the opening 30 is similarly determined considering the inclination angle. Then, corresponding to the inclination, as illustrated in FIGS. 5(a) to 6(b), the flat band body 8 at which the razor blades 5 are arranged is also obliquely inclined from the opening side roller 9 at a predetermined angle. The opening side inclined roller 9a is horizontally positioned to an opening surface of the opening 30. During shaving, bending the razor blades following a bone structure allows more comfortable shaving. In view of this, elastic characteristics of the flat band body 8 affect the portion between the opening side roller 9 and the opening side inclined roller 9a. Therefore, the thickness of the flat band body 8 is determined considering a used material, the following capability of the flat band body 8, or a similar condition.

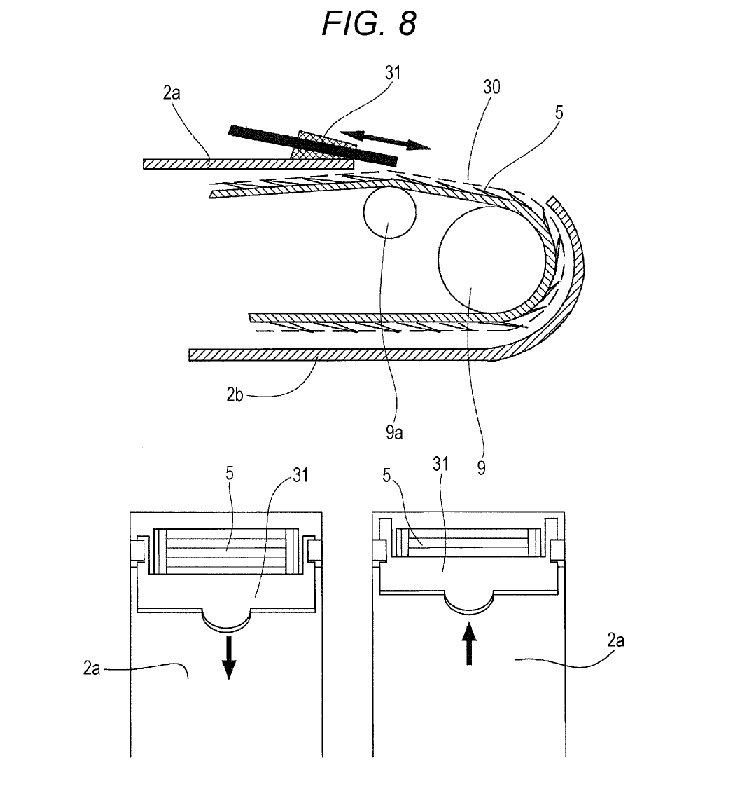

As illustrated in FIG. 8(a), the razor blades 5 at the flat band portion 8 contacting the opening side roller 9 rise, causing a close shave. In view of this, among the razor blades 5 exposed to the opening 30, a portion from the opening side roller 9 to the opening side inclined roller 9a is used. For close shave, disposing an opening for close shave at a distal end portion of the shaving case 2 is also effective.

When the feed mechanism feeds any given selected razor blade 5 to the opening 30 of the row razor 1, other razor blades 5 are fed to a back surface. Rotating the dial 13 with a finger or a similar tool feeds the flat band body 8. The rotational motion of the dial 13 is transmitted to the endless belt 8a through the handle side roller 10. The feed of the endless belt 8a feeds the razors 5 secured on the endless belt 8a. The rotation of the dial 13 downward viewed from the surface of the row razor 1 enters the razor blade 5 at the upper portion from the surface side of the row razor 1 into the case of the head row razor 1. Thus, the new razor blade 5 is brought up from the back surface. Repeating the rotation of the dial 13 can sequentially expose the razor blades 5 in the case from the opening 30.

The opening side roller securing portion 11 has convex portions 1101 corresponding to the engaged portions for feed mechanism 801 of the endless belt 8a (see FIG. 4(c)). The convex portions 1101 are disposed at the portions slightly forward with respect to the top surfaces of the opening side roller securing portions 11. The engaged portions for feed mechanism 801 of the endless belt 8a are disposed near the side surfaces of the secured positions of the razor head 4 and a head securing portion 6. The engaged portions for feed mechanism 801 have an effect of stopping the razor blade holding block 4 at an appropriate position when feeding the endless belt 8a. The convex portion 1101 has the following structure. The convex portion 1101 does not contact the endless belt 8a at the position where the convex portion 1101 engages the engaged portion for feed mechanism 801 of the endless belt 8a. However, at other positions, the convex portions 1101 are somewhat pressed to the side surface of the endless belt 8a. Accordingly, this has an effect of braking against the feed of the endless belt 8a. This also has an effect of preventing the endless belt 8a from being incautiously fed.

To stop the razor blade 5 and the razor blade holding block 4 at the appropriate secured position, the following structure may be employed. The present invention has a hole or a groove at a side surface of the roll, and the hole or the groove is pressed with an elastic member. Alternatively, the position of the head securing portion 6 is loosely restricted with a spring or a similar member.

### Embodiment 3

FIGS. 6(a) and 6(b) are explanatory views illustrating a mounting state to the shaving case in the one piece flat belt specification. FIG. 6(a) is a perspective view, and FIG. 6(b) are views of three surfaces. The drawings illustrate the one piece flat belt such that the one piece flat belt passes through the opening 30 and then is exited to the outside. The one piece flat belt may be inverted from the opening side roller 9 to the handle side roller 11 and then may be exited from the rear portion. Other constitutions are similar to the specification using the flat endless belt 8a, and therefore parts common to Embodiments 1 to 3 will not be further elaborated here.

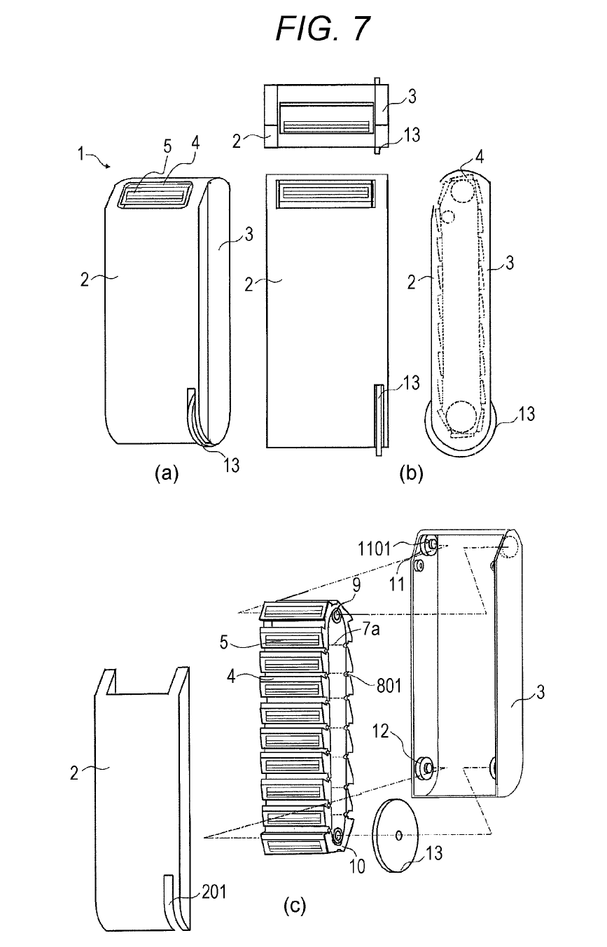

The following describes other embodiments using FIGS. 7(a) to 7(c). FIGS. 7(a) to 7(c) are explanatory views illustrating a mounting state to the shaving case in the case where the endless flat band body 8 is used. The flat band body 8 also has the configuration where the razor blade holding block 4 houses a group of the predetermined number of razor blades 5 and these razor blade holding blocks 4 are integrally formed sequentially via coupling portions. FIG. 7(a) is a perspective view, FIG. 7(b) are views of three surfaces, and FIG. 7(c) is an exploded view.

### Embodiment 4

This embodiment can house the plurality of razor blades 5 in the razor blade holding block 4. Moreover, any given razor blade holding block 4 can be easily selected and used. In view of this, for example, compared with the razor blade holding block 4 for three blades, when blades having different number of blades, such as four blades and five blades, or the plurality of kinds of razor blade holding blocks 4, such as the razor blade holding block 4 for female, can be housed, user's convenience can be further improved.

The razor blade holding block 4 is made of rubber or resin. The razor blade holding block 4 is shaped such that the razor blades 5 are sequentially arranged on an approximately flat base that is slightly inclined. The flat band body 8 is secured in a similar constitution to a new replacement blade for the razor head that is currently commercially available. However, the row razor 1 according to the present invention, due to deflection and pliantness specific to the belt of the flat band body 8 itself, has good following capability to a bone structure or a similar structure. In view of this, a special securing member is unnecessary. Specifically, various kinds of bonding methods such as fitting using a groove or a hole or adhesion can be considered.

Parts similar to Embodiments 1 to 3 are omitted. In the endless belt 8, the coupling portion coupling between these continuous razor blade holding blocks 4 are integrally formed. This coupling portion is arranged at a determined position, thickness and width that do not cause a problem in the rotation of the razor blade holding block 4 or a similar operation.

FIG. 8 is an explanatory view illustrating an opening area variable mechanism according to the present invention. The opening 30 includes an opening area variable mechanism 31. Accordingly, by the number of razor blades 5 arranged at the band-shaped body 8 or a similar specification, a region of hair to be shaved of any given width can be freely adjusted. Structurally, a simple slide mechanism as illustrated in FIG. 8 or a similar mechanism can be considered.

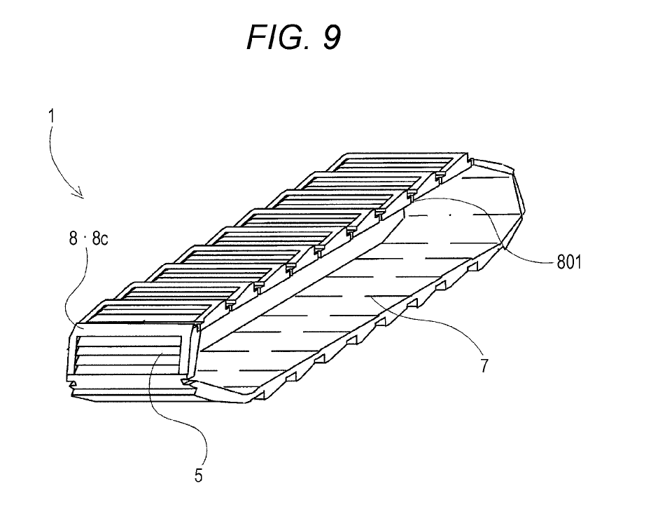

FIG. 9 is an explanatory view illustrating the flat band body 8 according to the present invention that has both the continuous razor blade holding blocks 4 and the endless type. In this constitution, since the part of the razor blade holding block 4 is thick and therefore is less likely to be bent, it is preferable that the material of the part be mainly rubber. When using resin as the material, the use of a resin material of large flexibility as much as possible and strength of the coupling portion coupling between the razor blade holding blocks 4 are considered. FIG. 9 illustrates the enlarged razor blade holding blocks 4. Thinning the width of one block (block width in the rotation direction) is effective to achieve downsizing of the roller portion and eventually thinning of the shaver case.

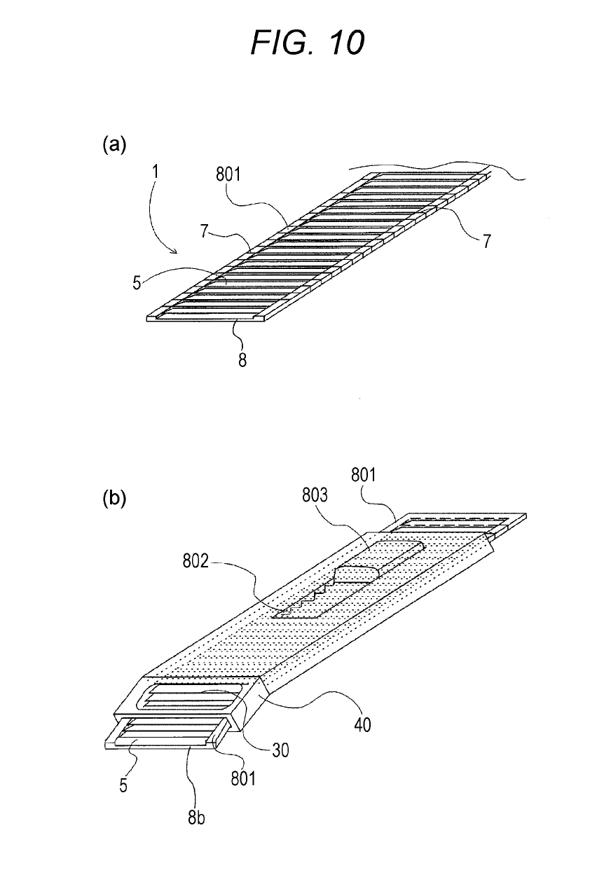

FIGS. 10(a) and 10(b) are explanatory views illustrating a mounting state to a simplified case in the one piece flat belt 8b specification. The flat band body 8 of the row razor 1 according to the present invention is the one piece flat belt 8b. A simplified shaver case 40 is employed as a case to be externally mounted. This simplified shaver case 40 is provided with a ratchet feed mechanism employed for general stationery cutter. However, the feed mechanism is not limited to this structure, and various kinds of structures can be considered. For example, performing a knurling finishing or a similar finishing on a planar portion of the engaged portion for feed mechanism of this one piece flat belt 8b or pasting a soft material of high friction resistance enhances friction force of the feed mechanism. A roller is pressed to the feed mechanism to perform feeding, and the feed mechanism is secured with a lock mechanism.

### INDUSTRIAL APPLICABILITY

The row razor 1 according to the invention is applicable to use at a hotel or a similar place, use for the case where a plurality of persons shares one razor to improve portability or a similar case, or as a razor for emergency saving or a similar purpose in addition to use at ordinary home. Thus, it is understood that industrial applicability of the row razor 1 according to the present invention is significant.

### DESCRIPTION OF REFERENCE SIGNS

1 Row razor
2 Shaver case
2a Front side shaver case
2b Back side shaver case
4 Razor blade holding block
5 Razor blade
5a Groove for mounting razor blade
7 Cut portion
7a Perforation
7b Groove for cutting
8 Flat band body
8a Endless belt
8b One piece flat belt
9 Opening side roller
9a Opening side inclined roller
10 Handle side roller
11 Opening side roller securing portion
12 Handle side roller securing portion
13 Dial
16 Endless belt guiding roller
19 Guide rail
30 Opening
40 Simplified shaver case
31 Opening area variable mechanism
801 Engaged portion for feed mechanism
802 Feed mechanism
803 Lever
1101 Convex portion

1. A row razor including a plurality of razor blades arranged in a row at a flat band body, wherein:
the razor blades are sequentially arranged at the flat band body providing a predetermined interval, and
the flat band body includes one or more of a flat belt shape or a flat endless belt shape using a material any one of or a combination of flexible resin, rubber, and metal, wherein
the razor includes:
cut portions disposed providing a predetermined interval, the cut portions being weakened to facilitate cutting; and
engaged portions for feed mechanism sequentially formed at an approximately edge portion on one side or both sides of the flat band body, the engaged portion for feed mechanism corresponding to a feed mechanism, the feed mechanism being disposed at an exterior body, the exterior body internally mounting the flat band body.

2. The row razor according to claim 1, wherein
the flat band body is integrally formed with razor blade holding blocks that have a continuous shape, the razor blade holding blocks holding a group of at least two or more of razor blades, and
the cutting portion is disposed between the razor blade holding blocks.

3. The row razor formed with a shaver case, the shaver case incorporating the row razor, the row razor according to claim 1, wherein
the shaver case covers the entire row razor blades, the shaver case having an opening, the opening exposing a part of a razor blade to be used such that the razor blade is brought into contact with skin, the shaver case being provided with a feed mechanism, the feed mechanism allowing selecting a razor blade at any given position arranged in a row in the row razor blades.

4. The row razor according to claim 3, wherein
the opening is provided with an opening area variable mechanism.

5. The row razor formed with a shaver case, the shaver case incorporating the row razor, the row razor according to claim 2, wherein
the shaver case covers the entire row razor blades, the shaver case having an opening, the opening exposing a part of a razor blade to be used such that the razor blade is brought into contact with skin, the shaver case being provided with a feed mechanism, the feed mechanism allowing selecting a razor blade at any given position arranged in a row in the row razor blades.

6. The row razor according to claim 5, wherein
the opening is provided with an opening area variable mechanism.
